(19) United States
(12) Patent Application Publication
(10) Pub. No.: US 2004/0013844 A1
(43) Pub. Date: Jan. 22, 2004

(54) Base plate used for the mounting of porcelain tiles and capable of eliminating the use of cement

(76) Inventor: Chen-Chi Mao, Taipei (TW)

Correspondence Address: BACON & THOMAS, PLLC, 625 SLATERS LANE, FOURTH FLOOR, ALEXANDRIA, VA, 22314

(21) Appl. No.: 10/196,186

(22) Filed: Jul. 17, 2002

(51) Int. Cl. B44C 1/26

(52) U.S. Cl. 428/67

(57) ABSTRACT

A base plate used for the mounting of porcelain tiles is disclosed. The base plate comprises a soft cushion and a multiple of hard supporting bodies disposed therein. The hard supporting bodies extend to the upper and lower surfaces of the soft cushion and may be disposed in the soft cushion in an orderly fashion or in a disorderly fashion. The upper surface of the soft cushion and the top surface of the hard supporting bodies are coated with a layer of pressure-sensitive glue, and a piece of paper is disposed on top of the layer for protection of the glue. The bottom surface of the tile can be adhered to the upper surface of the soft cushion. Each of the hard supporting bodies may be taken out from the soft cushion and may be inverted (with the glue-coated surface of each of them pointing down) and inserted back into the soft cushion, so that the glue-coated surface of each of them may be in contact with and adhere to the floor.

### BACKGROUND OF THE INVENTION

1. Field of the Invention

The present invention relates to a base plate used for the mounting of porcelain tiles. The base plate of the present invention has a soft cushion and a multiple of hard supporting bodies disposed therein. The base plate can eliminate the use of cement.

2. Description of the Prior Art

It is widely known that cement is used as the bonding agent for the mounting of porcelain tiles. Though the use of cement in such application enables tiles to be firmly bonded with the floor and to last a long time after installation, such use has several disadvantages. The first disadvantage is that it takes a certain period of time for cement to dry and this means the mounted tiles cannot be used in such period. Also, tiles mounted by cement are difficult to remove in a renovation. In addition, water is needed to mix cement with water and this may be problematic if water is not immediately available; also, the dust generated in the mixing of cement and water causes pollution to the environment. The most important disadvantage is that the use of cement in the application requires a skillful tile installer because the floor needs to be properly prepared, a certain thickness of cement is needed in order to hold tiles firmly in place, a certain width of gap should be kept between two tiles to cope with expansions and contractions due to the change in temperature and such gaps still have to be covered by cement. As other kinds of floor covering materials such as planks and plastic covers may be installed in a simple, DIY (do it yourself) manner, the use of the base plate of the present invention would be advantageous because the base plate allows easy installation and can eliminate the use of cement.

### SUMMARY OF THE INVENTION

The present invention relates to a base plate and a mounting method, so that cement, which has been used as the bonding agent in the conventional method in the mounting of porcelain tiles, would not be needed. The base plate of the present invention has a direct contact with the floor when being mounted. Most of base plate is made of a soft cushion, and a multiple of hard supporting bodies are disposed in the soft cushion. These hard supporting bodies usually extend to the upper and lower surfaces of the soft cushion and are disposed in the soft cushion in a “stand-up” or longitudinal manner. Also, these hard supporting bodies may be disposed in the soft cushion in an orderly fashion or in a disorderly fashion. In addition, these hard supporting bodies can have various configurations. In an embodiment, these hard supporting bodies are integrally formed with the soft cushion and cannot be separated from the soft cushion. In another embodiment, these hard supporting bodies are connected with the soft cushion in a detachable manner; that is, these hard supporting bodies may be detached from the soft cushion.

One surface of the aforesaid base plate may be coated with glue, so that such plate may become self-adhesive like the aforesaid plastic covers and hence is ready to be mounted along with a tile on the floor, eliminating the need to apply additional glue. Optionally, such base plate may not be pre-coated with glue. When a base plate with pre-coated glue and with detachable hard supporting bodies is mounted, we can first take out these hard supporting bodies, turn them upside-down and insert them back into the soft cushion, so that the glue-coated surfaces of these hard supporting bodies are pointing downwards and are ready to be bonded with the floor. One advantage is the easy removal of the base plate and the tile because the bonding strength of these hard supporting bodies is smaller than that of a soft cushion that is entirely coated with glue due to the difference in bonding area. Though the bonding strength of these hard supporting bodies is smaller than that of a soft cushion that is entirely coated with glue, such hard supporting bodies can provide sufficient bonding strength between the soft cushion and the floor.

During mounting, the bottom surface of a tile is adhered to the glue-coated surface of the base plate of the present invention. The base plate can provide two structural advantages. The first advantage is that the soft cushion can provide a great deal of strength against pulling and shear forces, so that the tile and the soft cushion can withstand the pulling and shear forces exerted by people walking and stepping on the tile after the tile is bonded with the base plate. The second advantage is that the hard supporting bodies provide sufficient rigidity and support to the entire tile because they are evenly distributed in the soft cushion, so that the damage due to pressure or gravity generated by walking or a heavy object may be avoided. How are gaps needed for expansions and contractions due to the change in temperature provided in the present invention? A cross-shaped positioning guiding tool is used. Such guiding tool has a U-shape cross-section. When tiles are mounted, each tile is resting against one of the four L-shape portions of the tool, so that a gap between two tiles may be formed by the groove and the width of such gap is equal to that of the groove. Also, a decorative strip may be placed in a groove of the tool, so that the decorative strip can be flush with the abutting two tiles after mounting and so that the gap may be covered by the strip.

From the above, we can see that the use of the base plates of the present invention in the mounting of tiles eliminates the use of cement, and the base plates of the present invention are ready to use. In addition, the use of the base plates of the present invention allows people to do it themselves (in a DIY manner) (without the need of professional tile installers). Moreover, the use of the base plates of the present invention allows the easy removal of the tiles

### BRIEF DESCRIPTION OF THE DRAWINGS

FIG. 1 is a perspective view of a base plate of the present invention.

FIG. 2 is a cross-sectional view of a base plate of the present invention

FIG. 3 is a cross-sectional view of a base plate of the present invention showing the base plate is adhered to a tile.

FIG. 4 is a perspective view of a guiding tool.

FIG. 5 is a top view of a guiding tool, illustrating how the tool is used to aid the mounting of tiles.

FIG. 6 is a cross-sectional view of a base plate of the present invention and a tile, illustrating the mounted condition of the tile by the use of the guiding tool.

FIG. 7 is a top view of another embodiment of a base plate of the present invention.

### DETAILED DESCRIPTION OF THE PREFERRED EMBODIMENT

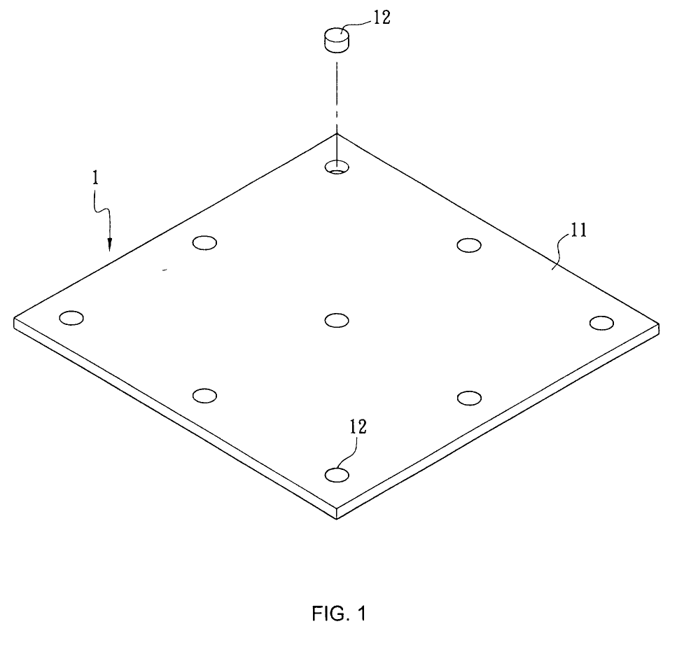

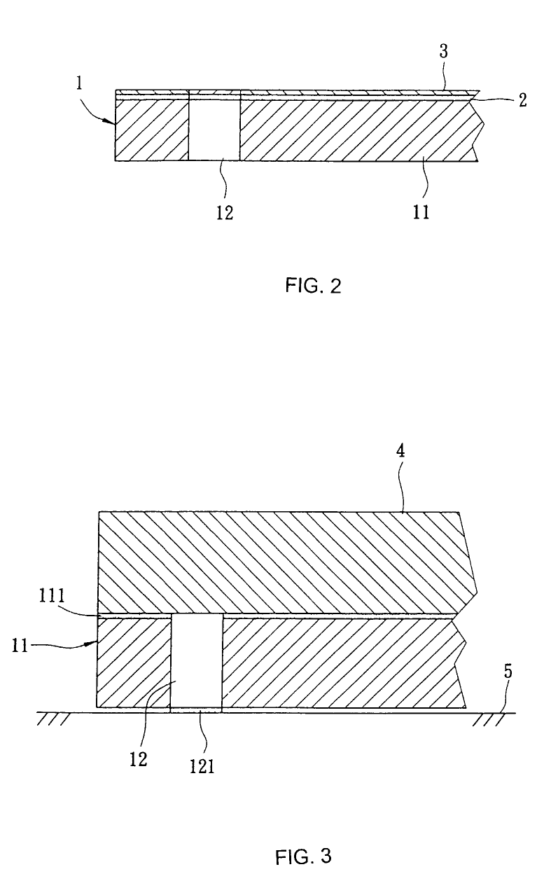

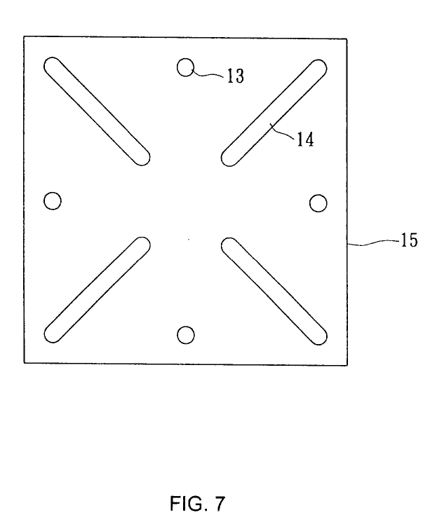

As illustrated in FIG. 1, the base plate 1 of the present invention comprises a soft cushion 11 and a multiple of hard supporting bodies 12. These hard supporting bodies 12 may be disposed in the soft cushion 11 in an orderly fashion or in a disorderly fashion. In one embodiment, these hard supporting bodies 12 are connected with the soft cushion 11 in a detachable manner. As illustrated in FIG. 2, the upper surface of the base plate 1 is coated with a layer of pressure-sensitive glue 2, and a piece of paper 3 is disposed on top of the layer for protection of the glue. These hard supporting bodies 12 can have various configurations and these bodies 12 may be disposed in the soft cushion 11 in various manners (not limited to the manner illustrated in FIG. 1). As illustrated in FIG. 7, hard supporting bodies 13, 14 have two configurations and these bodies are disposed in the soft cushion 15 in a manner different from that of FIG. 1.

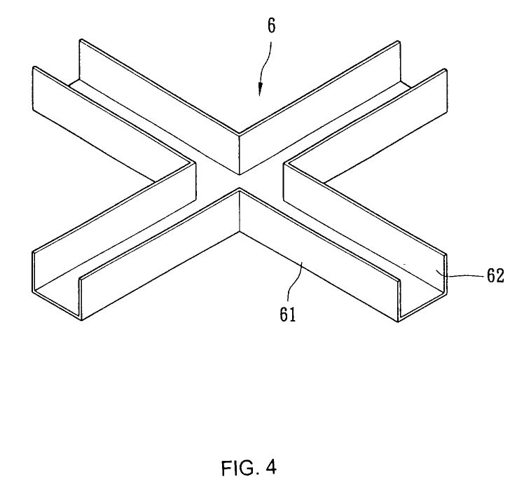

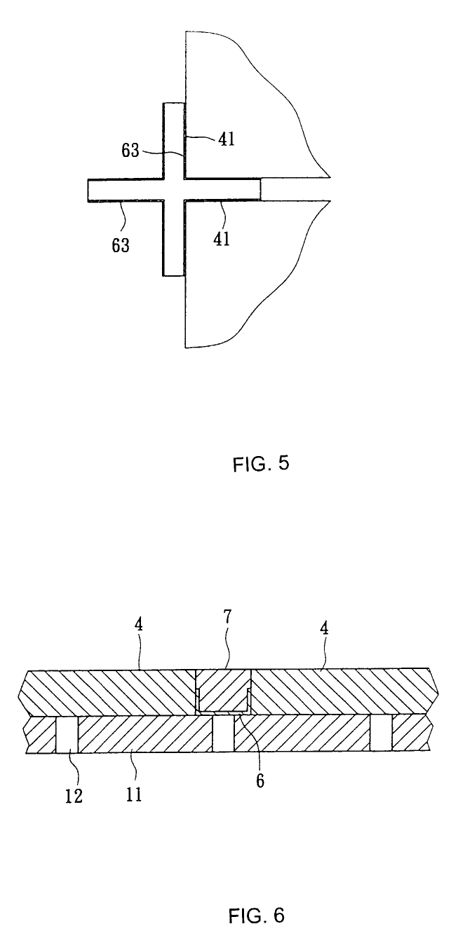

FIGS. 3 to 6 illustrate how the base plate of the present invention is mounted. First, the piece of paper 3 (not shown) of the base plate is torn off. Then, each of the hard supporting bodies 12 is taken out from the soft cushion 11 and is inverted and inserted back into the soft cushion 11 with the glue-coated surface 121 of each of them pointing down. Now, the bottom surface of the tile 4 can be adhered to the glue-coated surface 111 of the soft cushion 11, and the glue-coated surface 121 of each of the hard supporting bodies 12 can be adhered to the floor 5. When tiles 4 are mounted on a floor, a tool may be used to speed up the mounting operation. As illustrated in FIG. 4, such tool is a cross-shaped positioning guiding tool 6, which has walls 61 and four grooves 62. The guiding tool 6 can provide accurate positioning of tiles 4, so that tiles 4 may be mounted on a floor in an accurate manner. As illustrated in FIGS. 5 and 6, when tiles are mounted, the L-shape portion 41 of a tile 4 is resting against one of the four L-shape portions 63 of the tool 6. If a stronger bonding strength between the two is desired, a layer of glue may be applied between the two. Also, a decorative strip 7 may be placed in a groove of the tool 6, so that such strip 7 can cover the gap formed by the tool 7 between two tiles. In addition, the groove 62 can hold the strip 7 in place, so that the strip 7 may be firmly disposed between two tiles.

What is claimed is:

1. A base plate, used for the mounting of porcelain tiles and capable of eliminating the use of cement, comprising a soft cushion and a multiple of hard supporting bodies, the hard supporting bodies being disposed in the soft cushion, the hard supporting bodies extending to the upper and lower surfaces of the soft cushion and being disposed in the soft cushion in a longitudinal manner.

2. The base plate of claim 1, wherein the upper surface of the base plate is coated with a layer of pressure-sensitive glue.

3. The base plate of claim 1, wherein the hard supporting bodies are disposed in the soft cushion in a detachable manner.

4. The base plate of claim 3, wherein the hard supporting bodies may be taken out from the soft cushion and may be inserted back to the soft cushion.
